(19) United States
(12) Patent Application Publication
(10) Pub. No.: US 2014/0015178 A1
(43) Pub. Date: Jan. 16, 2014

(54) SPRING COMPONENTS, SYSTEMS, AND METHODS OF OPERATION AND MANUFACTURE

(71) Applicant: Liftwave, Inc., Boston, MA (US)

(72) Inventor: Blake Sessions, Cambridge, MA (US)

(21) Appl. No.: 13/938,017

(22) Filed: Jul. 9, 2013

Related U.S. Application Data
(60) Provisional application No. 61/669,985, filed on Jul. 10, 2012.

(51) Int. Cl. F16F 3/02

(52) U.S. Cl. CPC F16F 3/023
USPC 267/164; 29/896.9

(57) ABSTRACT

The present disclosure provides a spring system comprising at least one bilaterally tapered flexion spring and a spring interface coupled to the at least one bilaterally tapered flexion spring.

### CROSS REFERENCE TO RELATED APPLICATIONS

The present application claims priority to U.S. Provisional Application No. 61/669,985, filed Jul. 10, 2012 and entitled “Flight Source Spring Array Technology,” which application is incorporated herein by reference in its entirety.

### TECHNICAL FIELD

The present application relates generally to the field of springs. More specifically, the present application relates to components and systems for cooperatively implementing flexion springs.

### BACKGROUND

There are various disadvantages associated with existing leaf spring designs, including composite leaf springs. Three of those disadvantages are related to achieving a constant-stress outer surface, the large length or net envelope of those types of springs, and the difficulty of integrating those designs into various applications.

In connection with achieving a constant-stress outer surface and thereby providing an efficient load condition, existing composites employ manufacturing techniques such as using a CNC grinding tool to impose an approximately square root profile onto the spring and then laminating the outer surfaces with fabric of fiberglass or carbon fiber and epoxy resin. This process is generally time consuming, costly, and may negatively impact the spring by reducing the allowable stress in the spring member as the interface between the epoxied fabric and the pultrusion “core” contains a discontinuity of material properties.

In connection with the large length of springs such as leaf springs, using a single flexion member to obtain a requisite load, deflection, and energy typically requires using a spring section that is very long. While the length may be desirable in limited applications, for example in applications where the length also acts as a leveraging arm, the length of a leaf spring may limit its potential applications. For example, when compared to a steel coil spring, while a leaf spring that can handle the same load may be superior to a coil spring with regards to net material efficiency, the leaf spring is disadvantaged in terms of the net envelope. As a result, there exist a significant number of spring applications that employ heavy and compact coil springs made of steel instead of leaf springs.

Thirdly, in connection with integration, leaf springs are generally fraught with difficulties related to their implementation as they generally undergo distinct stress concentrations, may be less stable, and require accounting for kinematic non-linearities in order to achieve a desired mechanical behavior.

### SUMMARY

The inventor has appreciated that flexion spring elements may be efficiently and effectively presented in a compressible two-force member design form through inventive embodiments disclosed herein. Such inventive components and systems provide various advantages, some of which are related to their efficiency, size, and integration

One exemplary inventive embodiment provides a spring system that includes at least one bilaterally tapered flexion spring and a spring interface coupled to the at least one bilaterally tapered flexion spring in a three point interfacing configuration. The three point interfacing configuration includes a first interface positioned on a first side of the at least one bilaterally tapered flexion spring and a second interface and a third interface. The second interface and the third interface are positioned on a second side of the at least one bilaterally tapered flexion spring. The second side of the at least one bilaterally tapered flexion spring is opposite the first side of the at least one bilaterally tapered flexion spring. The first interface is positioned between the second interface and the third interface along a length of the at least one bilaterally tapered flexion spring.

In various embodiments, the at least one bilaterally tapered flexion spring includes an array of bilaterally tapered flexion springs. The bilaterally tapered flexion springs in the array of bilaterally tapered flexion springs coupled to the spring interface in the three point interfacing configuration. The array of bilaterally tapered flexion springs may be coupled to a first end cap at a first end of the bilaterally tapered flexion springs in the array of bilaterally tapered flexion springs and may be coupled a second end cap at a second end of the bilaterally tapered flexion springs in the array of bilaterally tapered flexion springs. The first end cap may be positioned, at least in part, between the spring interface and the bilaterally tapered springs at the second interface and the second end cap may be positioned, at least in part, between the spring interface and the bilaterally tapered springs at the third interface. The first end cap and the second end cap may include a u-shaped channel. The first end cap and the second end cap may include a plurality of slots configured to engage the bilaterally tapered flexion springs.

In various embodiments, the bilaterally tapered flexion springs are composed of fiberglass.

The first interface of the spring interface may include a curved surface, in accordance with various embodiments.

The second and third interfaces may include a plurality of ribs on the spring interface, in accordance with various embodiments.

The first side of the at least one bilaterally tapered flexion spring and the second side of the at least one bilaterally tapered flexion spring are parallel to a direction of the bilateral taper, in accordance with various embodiments.

Another exemplary inventive embodiment provides a spring system including a first spring interface coupled to a first bilaterally tapered flexion spring in a first three point interfacing configuration. The first three point interfacing configuration includes a first interface positioned on a first side of the first bilaterally tapered flexion spring and a second interface and a third interface positioned on a second side of the first bilaterally tapered flexion spring. The second side of the first bilaterally tapered flexion spring is opposite the first side of the first bilaterally tapered flexion spring. The first interface is positioned between the second interface and the third interface along a length of the first bilaterally tapered flexion spring. The spring system further includes a second spring interface bilaterally connected to the first spring interface via a first pivotal joint and a second pivotal joint. The second spring interface is coupled to a second bilaterally tapered flexion spring in a second three point interfacing configuration. The second three point interfacing connection includes a fourth interface positioned on a first side of the second bilaterally tapered flexion spring and a fifth interface and a sixth interface positioned on a second side of the second bilaterally tapered flexion spring. The second side of the second bilaterally tapered flexion spring is opposite the first side of the second bilaterally tapered flexion spring. The fourth interface is positioned between the fifth interface and the sixth interface along a length of the second bilaterally tapered flexion spring.

The bilaterally tapered flexion springs may be composed of fiberglass in accordance with various embodiments.

The first bilaterally tapered flexion spring includes a first array of bilaterally tapered flexion springs, each bilaterally tapered flexion spring in the first array coupled to the first spring interface in the first three point interfacing configuration, in accordance with various embodiments.

The second bilaterally tapered flexion spring includes a second array of bilaterally tapered flexion springs, each bilaterally tapered flexion spring in the second array coupled to the spring interface in the second three point interfacing configuration, in accordance with various embodiments.

The first array of bilaterally tapered flexion springs may be coupled to a first end cap at the first end of the bilaterally tapered flexion springs in the first array and to a second end cap at the second end of the bilaterally tapered flexion springs in the first array and the second array of bilaterally tapered flexion springs may be coupled to a third end cap at the first end of the bilaterally tapered flexion springs in the second array and to a fourth end cap at the second end of the bilaterally tapered flexion springs in the second array.

In various embodiments, the first end cap and the second end cap include a u-shaped channel.

The first pivotal joint and the second pivotal joint may include a bearing. The bearing may include a journal bearing.

In various embodiments, the bearing is a part of at least one the first spring interface and the second spring interface.

The first spring interface and second spring interface include a first plurality of ribs in the first spring interface positioned adjacent to the first pivotal joint and include a second plurality of ribs in the second spring interface positioned adjacent to the second pivotal joint, in accordance with various embodiments.

Another exemplary inventive embodiment provides a spring system that includes an array of bilaterally tapered flexion springs. The bilaterally tapered flexion springs in the array are shaped such that a width of the bilaterally tapered flexion springs decreases, at least in part, along a length of the bilaterally tapered flexion springs from a central region of the bilaterally tapered flexion springs to a first end of the bilaterally tapered flexion springs and the width of the bilaterally tapered flexion springs decreases, at least in part, along the length of the bilaterally tapered flexion springs from the central region of the bilaterally tapered flexion springs to a second end, where the second end is opposite the first end. The spring system further includes a first end cap coupled to the first end of the bilaterally tapered flexion springs in the array of bilaterally tapered flexion springs and a second end cap coupled to the second end of the bilaterally tapered flexion springs in the array of bilaterally tapered flexion springs. The first end cap and the second end cap may include a u-shaped channel.

In accordance with one exemplary inventive embodiment, a method of manufacturing a spring system is provided. The method includes coupling a first bilaterally tapered flexion spring to a first spring interface in a first three point interfacing configuration. The first three point interfacing configuration includes a first interface positioned on a first side of the first bilaterally tapered flexion spring and a second interface and a third interface positioned on a second side of the first bilaterally tapered flexion spring. The second side of the first bilaterally tapered flexion spring is opposite the first side of the first bilaterally tapered flexion spring. The first interface is positioned between the second interface and the third interface along a length of the first bilaterally tapered flexion spring. The method further includes coupling a second bilaterally tapered flexion spring to a second spring interface in a second three point interfacing configuration, the second three point interfacing connection including a fourth interface positioned on a first side of the second bilaterally tapered flexion spring and a fifth interface and a sixth interface positioned on a second side of the second bilaterally tapered flexion spring. The second side of the second bilaterally tapered flexion spring is opposite the first side of the second bilaterally tapered flexion spring. The fourth interface is positioned between the fifth interface and the sixth interface along a length of the second bilaterally tapered flexion spring. The method also includes bilaterally coupling the first spring interface to the second spring interface via a first pivotal joint and a second pivotal joint.

In one embodiment, the modular fiberglass compression spring consists of a serial arrangement of load modules, in a manner similar to a revolution of steel wire in a coil spring design. The load module may be stacked in series as many times as appropriate for the application. This module, loadable from its end surfaces in two force member compression, includes two sets of flexion springs in opposing three point bending load configurations. As such multiple modules may be on one another in accordance with various embodiments to provide a large number of individual spring elements working in harmony to provide a net spring motion, within a relatively small form factor. Furthermore, the shape of each spring element is such that it may be implemented without fusing or chemical bonding, thereby significantly reducing the cost and effort of creating the assembly. Various embodiments disclosed herein thus provide a net two force member load condition component from three point bending elements.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawing primarily is for illustrative purposes and is not intended to limit the scope of the inventive subject matter described herein. The drawing is not necessarily to scale; in some instances, various aspects of the inventive subject matter disclosed herein may be shown exaggerated or enlarged in the drawings to facilitate an understanding of different features. In the drawing, like reference characters generally refer to like features (e.g., functionally similar and/or structurally similar elements).

FIG. 1 is a perspective view of a single flexion spring in accordance with exemplary inventive embodiments.

FIG. 2 is top view of a coupled array of flexion springs of FIG. 1 in accordance with exemplary inventive embodiments.

FIG. 3 illustrates a pair of coupled array of flexion springs of FIG. 2.

FIG. 4 provides a perspective view of a spring interface in accordance with exemplary inventive embodiments.

FIG. 5 shows a side view of the spring interface of FIG. 4.

FIG. 6 shows a bottom view of the spring interface of FIG. 4.

FIG. 7 illustrates a perspective view of spring system including a pair of coupled arrays of FIG. 2 connected to spring interfaces of FIG. 4 in accordance with exemplary inventive embodiments.

FIG. 8 provides a side view of the spring system of FIG. 7.

FIG. 9 provides a side view of the spring system of FIG. 7 in a flexed state.

FIG. 10 illustrates a stacked set of spring systems of FIG. 7 in accordance with exemplary inventive embodiments.

The features and advantages of the inventive concepts disclosed herein will become more apparent from the detailed description set forth below when taken in conjunction with the drawings.

### DETAILED DESCRIPTION

Following below are more detailed descriptions of various concepts related to, and exemplary embodiments of, inventive systems, methods and components providing a spring system

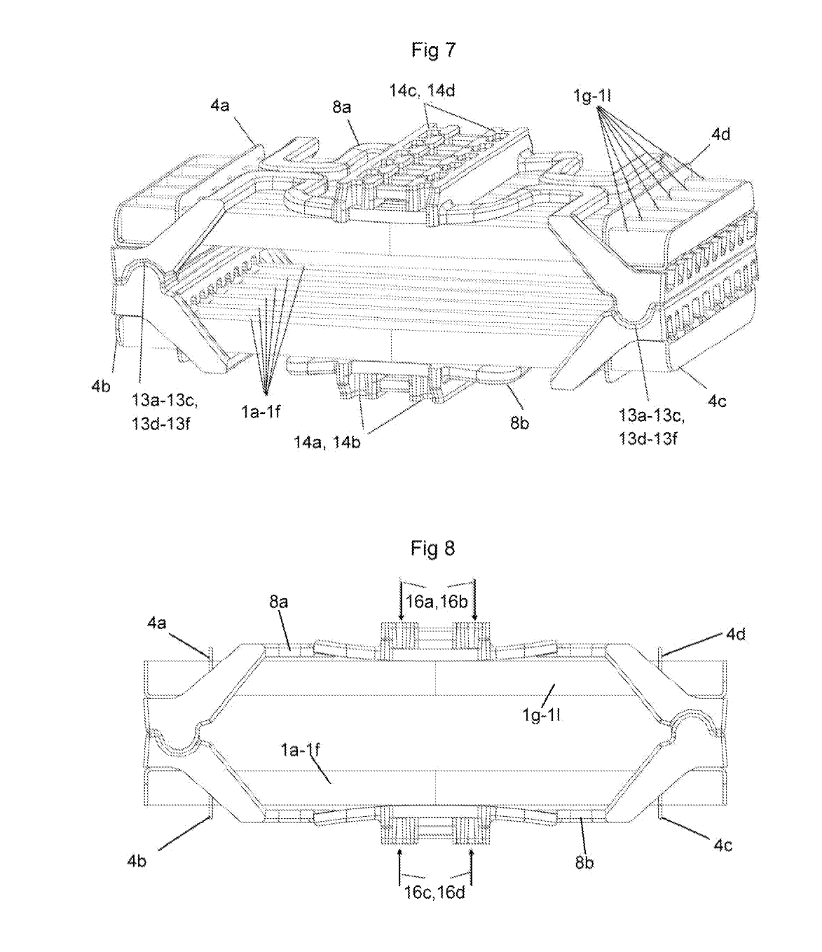

Various inventive embodiments include a repeating unit of load module, depicted in its entirety in FIG. 7 and FIG. 8. The external interaction with this module, for example by a compressive force represented by vectors 16a,16b and 16c,16d may be input at surfaces 14a,14b and 14c,14d, which are compressed towards each other via vectors 16a,b and 16c,16d. In this embodiment, the surfaces 14a,14b and 14c,14d are distinct; however, in various embodiments they may be integrally connected for actuation as a single load surface by a singly centered compression load vector. A net spring effect, with the forces evident at the surfaces being proportional to the relative displacement of said surfaces, is observed in conjunction with amount of frictional impedance.

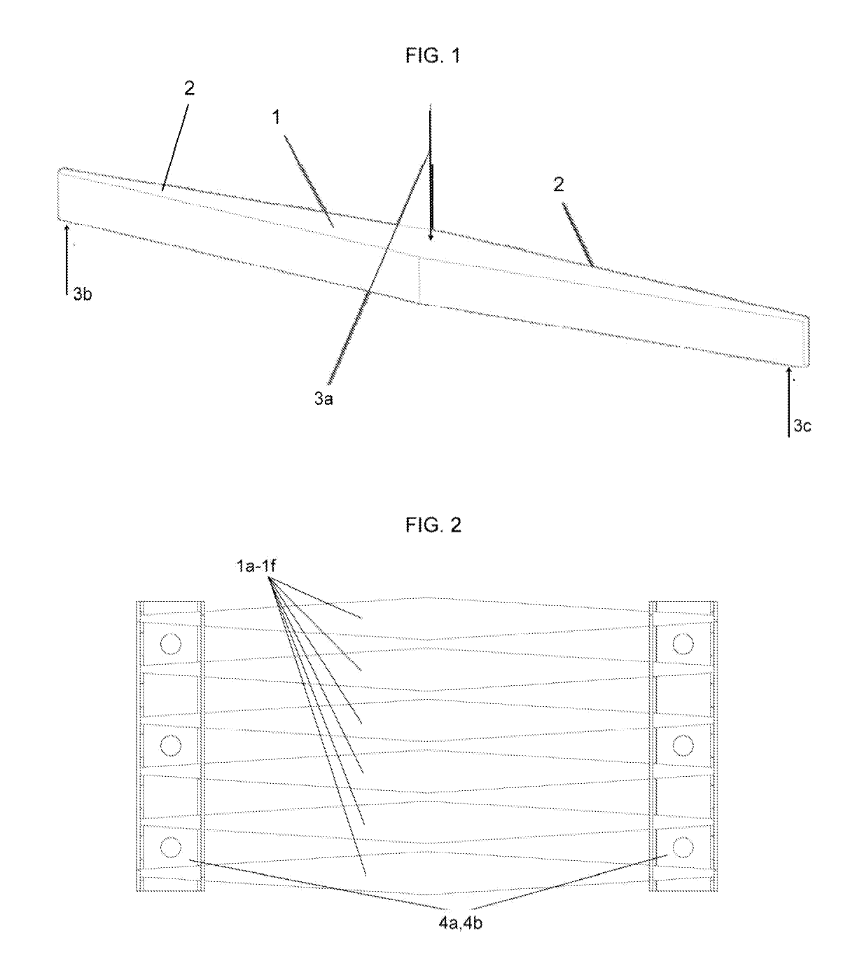

The base constituent of the embodiment illustrated in FIGS. 7 and 8 is shown in FIG. 1. FIG. 1 provides a perspective view of a single flexion spring in accordance with exemplary inventive embodiments. A bilaterally tapered flexion spring body 1 is loaded in symmetric three-point bending as demonstrated by vectors 3a-3c. As oriented in FIG. 1, the spring would assume a “smiling” or concave form under loads applied in the direction demonstrated by vectors 3a-3c. Spring body 1 is bi-laterally tapered, such that the width of the spring decreases, at least in part, along a length of the bilaterally tapered flexion springs from a central or intermediate region of the bilaterally tapered flexion springs to a first end of the bilaterally tapered flexion springs and the width of the bilaterally tapered flexion springs decreases, at least in part, along the length of the bilaterally tapered flexion springs from the central or intermediate region of the bilaterally tapered flexion springs to a second end, where the second end opposite the first end. The taper, 2, may generally be of a shallow angular value so as to prevent the material from failing due to shearing of the epoxy matrix along fiber lines. Accordingly, the spring 1, may have a diamond form or a truncated diamond form, the latter of which is illustrated by springs 1a-1f in FIG. 2. This form has various advantages, which include improved geometric material efficiency factor by approximately a factor of three as compared with an element having a constant cross section under the same load condition. Secondly, the form allows it to be more easily manufactured.

Bilaterally tapered flexion spring body 1 may be composed of a fiber-aligned composite material in accordance with various inventive embodiments. Spring body 1 may be composed of a composite such as fiberglass in various embodiments. Spring body 1 may be manufactured by cutting the composite material into a bilaterally tapered configuration via a device configured to cut with abrasive methods such as a water-jet, a saw, or a diamond wire cutter.

FIG. 2 is top view of a coupled array of flexion springs of FIG. 1 in accordance with exemplary inventive embodiments. FIG. 2 depicts six spring bodies 1a-f arranged along an axis perpendicular to both the deflection axis and the length axis defined by the spring. The number of spring bodies is demonstrated in FIG. 2 is illustrative. Various embodiments may include a different number of flexion springs, such as one flexion spring, four flexion springs, nine flexion springs, etc. Spring bodies 1a-1f flex in unison, each in three-point bending, as depicted in FIG. 1. End caps 4a,4b are shown on ends of springs 1-1f, which end caps join springs 1a-1f into a single flexion body.

FIG. 3 illustrates a pair of coupled arrays of flexion springs of FIG. 2. Four end caps 4a-4d are evident in FIG. 3, along with two sets of spring bodies 1a-1f, 1g-1 that are here referred to as spring sets 5a,5b. The end caps 4a-4d serve a variety of purposes. In various embodiments, end caps 4a-4d are composed of a bent sheet-metal construction that may be formed by various processes such as, water-jetting, laser cutting, or punch forming process. Each end cap has two primary load surfaces, one in contact with the ends of each spring body, the other larger flat surface contacting the spring interface 8. Holes 6a-6c provide a shear interface between the end caps 4a-4d and the spring interfaces 8a,8b. The “U-shaped” channel form of end caps 4a-4d provides a high structural bending stiffness that distributes the concentrated loads applied by the spring ends into a distributed load along the flat surface of end caps 4a-4d. End caps 4a-4d also include, rectangular holes or slots 7, through which the ends of the springs slide in the assembly process. These holes maintain the structural integrity of the part, and provide an appropriate location for the load surface on the springs. Furthermore, if undersized slightly with respect to a peripheral portion of the corresponding contacting spring, holes 7 provide a binding frictional effect at the contact point 7a. Such an effect helps prevent end caps 4a-4d from sliding off the ends of spring sets 5a,5b during deflection when friction may not be satisfactorily holding the end caps in place onto the spring sets.

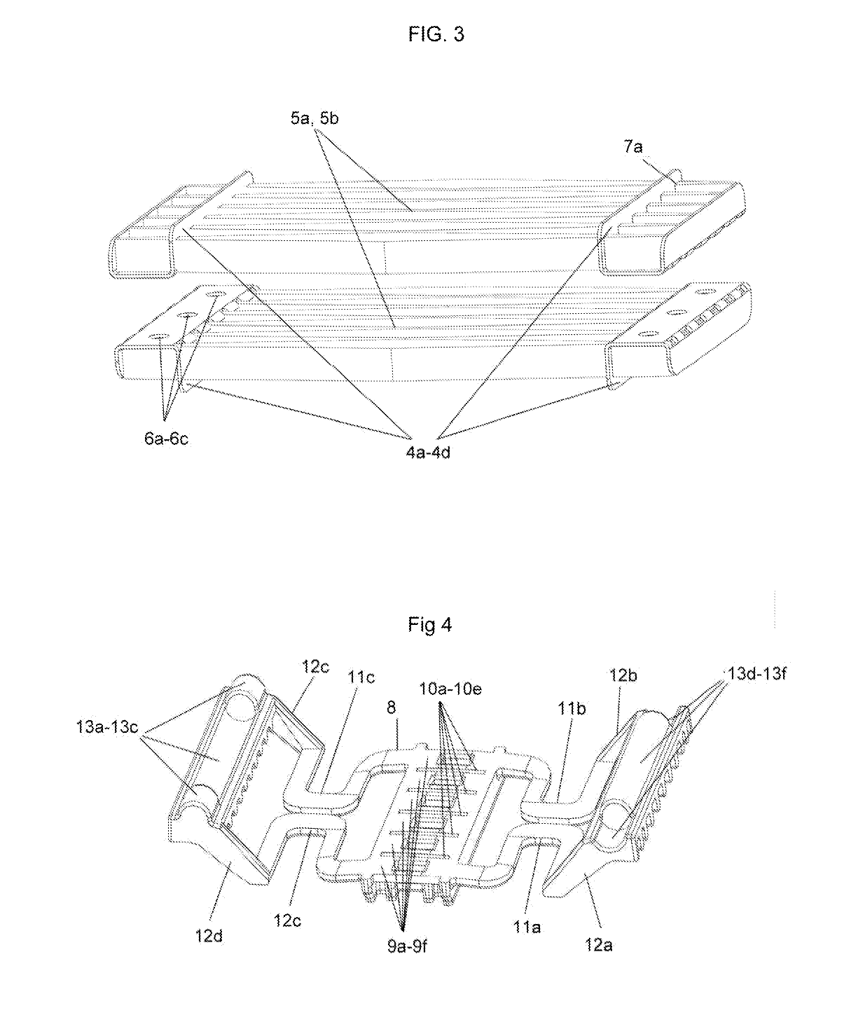

FIG. 4 provides a perspective view of a spring interface in accordance with exemplary inventive embodiments. Spring interface 8 is configured to engage one or more bilaterally tapered springs in a three point interfacing configuration. In various embodiments, spring interface 8 may include a multifunction injection-molded component designed to complement the composite spring sets, supplying structural load, stability, alignment, and bearing functionalities. One of the interfaces is provided via curved load surfaces 9a-9f that contact spring bodies 1a-1f directly to provide the center load constituent for the three point bending (e.g. load 3a). In various embodiments, spring interface 8 may include vertical slots 10a-e, which permit the utilization of tension components which supply tension in order to preload the spring module. The ends of spring interfaces 8 include rounded load surfaces 13a-13c, 13d-13f that also function as journal bearing surfaces. The load surfaces need not be three distinct surfaces as illustrated here, but are illustratively demonstrated in this manner to integrate an axial alignment into the functionality of that geometry. Ribs 17 are evident underneath load surfaces 13a-13c, 13d-13f, which ribs provide the other two interfaces of the three point interfacing configuration, which two lateral interfaces help transmit compression forces through end caps 4a-4d into the lateral ends of the spring bodies 1a-1f in order to supply the two lateral load constituents (e.g. 3b and 3c of FIG. 1) for the three point bending and also permit maintaining a constant wall thickness of an injection molded spring interface design.

As illustrated in FIG. 4, spring interface 8 may be implemented as a single body, but is not limited to the same. For example, the spring interface may be implemented as three bodies as described above: a center compression “plunger” 9a-f along with two discrete bearing ends 13a-f. As disclosed herein, it may be preferable in various embodiments for spring interface 8 to be implemented as a single body, for example to reduce the number of components that must be manufactured (by a factor of 3) as well as to provide a stable and centered placement for the center plunger 9a-9f relative to the bearing ends 13a-13f. Arms 12a-12d connect the different material planes permitting interfaces on the top and bottom of the bilaterally tapered springs, and U-shaped flexures 11a-11d connect the lateral bodies to the center body. Flexures 11a-11d are designed to comply with the motion of the springs themselves, as relative motion is experienced between the end caps and the center plunger during spring deflection. This motion involves both a linear and angular differential between each bearing end and the center plunger. The approximate “S” shape of each flexure 11a-11d permits compression along an axis between the lateral bearing ends of spring interface 8 and the center plunger portion of interface 8, thereby causing peak stresses in the sections of highest offset geometry. Torsion of the beams of the flexure, which are collinear with the bearing axes 13a-13f correspond to the imposed angular geometric differential.

FIG. 5 shows a side view of the spring interface 8 of FIG. 4. Some features such as 9a-9f, 11a-11d, 12a-12d, and 13a-13f described in connection with other FIGS. are pointed out in FIG. 5 for further clarity. Surfaces 14a,14b oppose surfaces 9a-9f, and compression (demonstrated by vectors 16a,b in FIG. 8) placed upon the surfaces 14a,14b is structurally transferred to compression at surfaces 9a-9f.

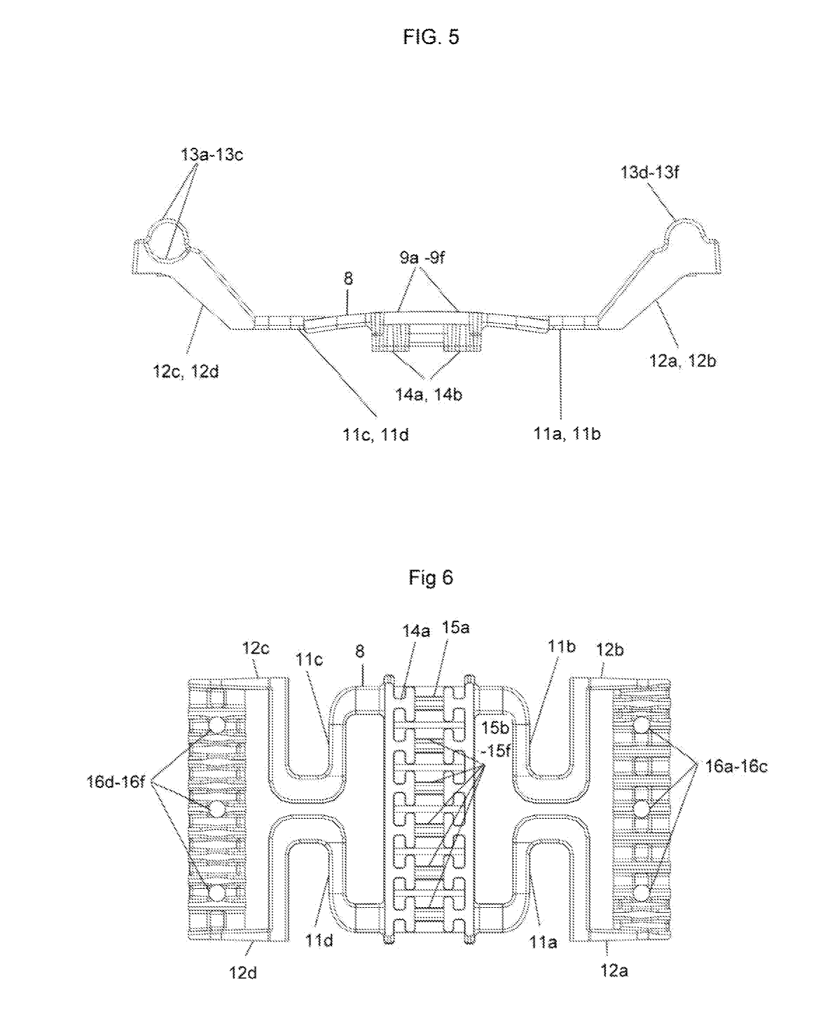

FIG. 6 shows a bottom view of the spring interface of FIG. 4. FIG. 6 shows, recesses 15a-15f. Recesses 15a-15f in spring load surfaces 9a-9f provide an offset geometry that increases structural stiffness. Circular bosses 16a-16f are also visible from this bottom view in FIG. 6. Circular bosses 16a-16f engage holes 6a-6f in end caps 4a-4d. Accordingly the engagement of bosses 16a-16f with holes 6a-6f provides an interface for shear transmission between spring interface 8 and end caps 4a-4d. Bosses 16a-16f may include other non-circular shapes in accordance with various embodiments, however it may be convenient for them to be circularly shaped as this permits them to function as ejector pin pads in the molding process.

FIG. 7 illustrates a perspective view of a spring system including a pair of coupled arrays of FIG. 2 connected to spring interfaces of FIG. 4 in accordance with exemplary inventive embodiments. FIG. 7 is an integrated view of a complete load module, illustrating for purposes of clarity many of the aforementioned bodies and features. The spring interface 8a is self-interlocking, mating with spring interface 8b (identical in the illustrated embodiment to interface 8a) at the bearing surfaces 13a-13c and 13d-13f. Eighteen bodies are illustrated in the load module assembly: 12 bilaterally tapered spring bodies 1a-1f and 1g-1l, two spring interfaces 8a,8b, and four sheet metal end caps 4a-4d.

Compressive loads at surfaces 14c,14d transmit through the plunger structure to surfaces 9a-9f, applying compression to the center of spring bodies 1g-1l as the center component of their three point bending load conditions 3a-3c. The ends of the spring bodies 1g-1l apply compression through end caps 4a, 4d, which distribute the concentrated loads through to the underside of the bearing ends of spring interface 8a. The bearing surfaces 13a-13f of spring interface 8a transmit compression through rotation to the bearing surfaces of spring interface 8b, which push the compression through end caps 4b, 4c. The spring bodies 1a-1f experience three point bending and transmit the load through to contact surfaces 9a-9f of spring interface 8b, which in turn transmits the load out of the structure at surfaces 14a,14b.

FIG. 8 provides a side view of the spring system of FIG. 7. FIG. 8 shows the external interaction with the load module. Loads 16a,16b from either an adjacent load module or from an end condition to the stack of load modules act compressively through surfaces 14a,14b. The response to said loads are 16c,16d at the opposing pair of surfaces, again delivered either by an adjacent load module or by an end condition to the stack of load modules. As mentioned, a net spring effect between these two locations is evident.

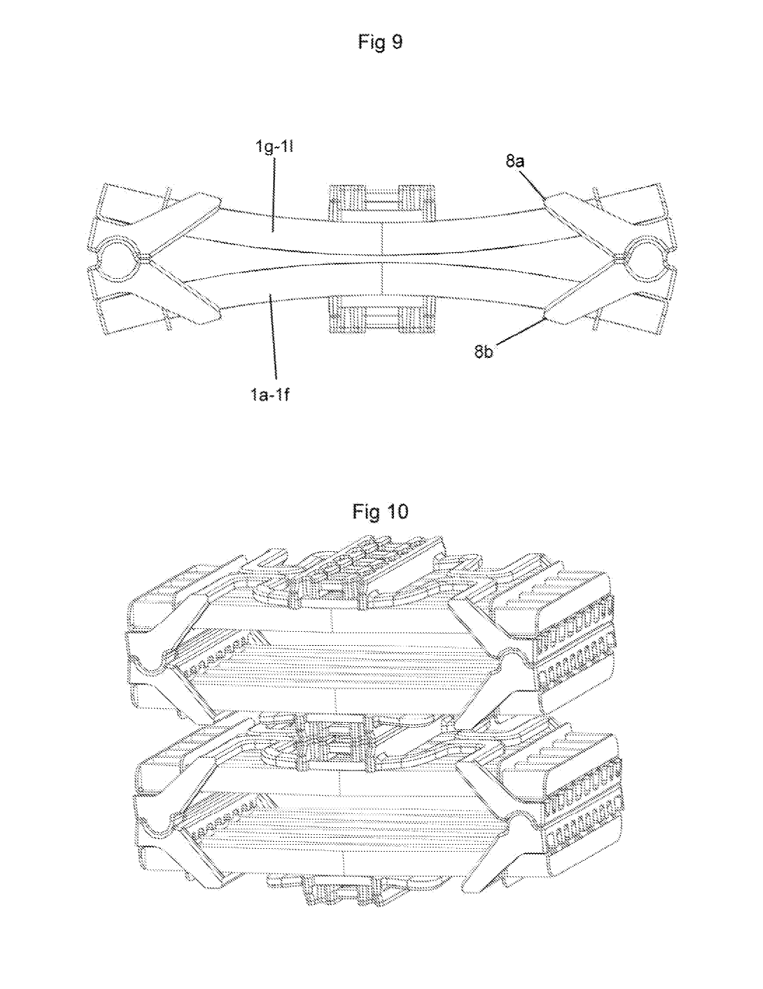

FIG. 9 provides a side view of the spring system of FIG. 7 in a flexed state, for example under compression.

FIG. 10 illustrates a stacked set of spring systems of FIG. 7 in accordance with exemplary inventive embodiments. More specifically, FIG. 10 depicts two load modules in series, which as a unit provides the same peak compression force value, but with twice the deflection value of a single load module. The design of the load module is such that an arbitrary number of load modules may be stacked in series to provide a deflection linearly related to the number of modules in series. The end product may be sold as a single load module, intended for the end user to stack to a suitable preference, or it may be sold as an internalized stack of a number of modules encased in a single functional component in accordance with various embodiments.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of spring systems or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A spring system comprising:
at least one bilaterally tapered flexion spring; and
a spring interface coupled to the at least one bilaterally tapered flexion spring in a three point interfacing configuration, the three point interfacing configuration including a first interface positioned on a first side of the at least one bilaterally tapered flexion spring and a second interface and a third interface, the second interface and the third interface positioned on a second side of the at least one bilaterally tapered flexion spring, the second side of the at least one bilaterally tapered flexion spring opposite the first side of the at least one bilaterally tapered flexion spring, the first interface positioned between the second interface and the third interface along a length of the at least one bilaterally tapered flexion spring.

2. The spring system according to claim 1, wherein the at least one bilaterally tapered flexion spring includes an array of bilaterally tapered flexion springs, the bilaterally tapered flexion springs in the array of bilaterally tapered flexion springs coupled to the spring interface in the three point interfacing configuration.

3. The spring system according to claim 2, wherein the array of bilaterally tapered flexion springs is coupled to a first end cap at a first end of the bilaterally tapered flexion springs in the array of bilaterally tapered flexion springs and wherein the array of bilaterally tapered springs is coupled a second end cap at a second end of the bilaterally tapered flexion springs in the array of bilaterally tapered flexion springs.

4. The spring system according to claim 3, wherein the first end cap is positioned, at least in part, between the spring interface and the bilaterally tapered springs at the second interface and the second end cap is positioned, at least in part, between the spring interface and the bilaterally tapered springs at the third interface.

5. The spring system according to claim 3, wherein the first end cap and the second end cap include a u-shaped channel.

6. The spring system according to claim 5, wherein the first end cap and the second end cap include a plurality of slots configured to engage the bilaterally tapered flexion springs.

7. The spring system according to claim 1, wherein the bilaterally tapered flexion springs are composed of fiberglass.

8. The spring system according to claim 1, wherein the first interface includes a curved surface.

9. The spring system according to claim 1, wherein the second and third interfaces include a plurality of ribs on the spring interface.

10. The spring system according to claim 1, wherein the first side of the at least one bilaterally tapered flexion spring and the second side of the at least one bilaterally tapered flexion spring are parallel to a direction of the bilateral taper.

11. A spring system comprising:
a first spring interface coupled to a first bilaterally tapered flexion spring in a first three point interfacing configuration, the first three point interfacing configuration including a first interface positioned on a first side of the first bilaterally tapered flexion spring and a second interface and a third interface positioned on a second side of the first bilaterally tapered flexion spring, the second side of the first bilaterally tapered flexion spring opposite the first side of the first bilaterally tapered flexion spring, the first interface positioned between the second interface and the third interface along a length of the first bilaterally tapered flexion spring; and
a second spring interface bilaterally connected to the first spring interface via a first pivotal joint and a second pivotal joint, the second spring interface coupled to a second bilaterally tapered flexion spring in a second three point interfacing configuration, the second three point interfacing connection including a fourth interface positioned on a first side of the second bilaterally tapered flexion spring and a fifth interface and a sixth interface positioned on a second side of the second bilaterally tapered flexion spring, the second side of the second bilaterally tapered flexion spring opposite the first side of the second bilaterally tapered flexion spring, the fourth interface positioned between the fifth interface and the sixth interface along a length of the second bilaterally tapered flexion spring.

12. The spring system according to claim 8, wherein the bilaterally tapered flexion springs are composed of fiberglass.

13. The spring system according to claim 8, wherein the first bilaterally tapered flexion spring includes a first array of bilaterally tapered flexion springs, each bilaterally tapered flexion spring in the first array coupled to the first spring interface in the first three point interfacing configuration.

14. The spring system according to claim 13, wherein the second bilaterally tapered flexion spring includes a second array of bilaterally tapered flexion springs, each bilaterally tapered flexion spring in the second array coupled to the spring interface in the second three point interfacing configuration.

15. The spring system according to claim 14, wherein the first array of bilaterally tapered flexion springs is coupled to a first end cap at the first end of the bilaterally tapered flexion springs in the first array and to a second end cap at the second end of the bilaterally tapered flexion springs in the first array, and wherein the second array of bilaterally tapered flexion springs is coupled to a third end cap at the first end of the bilaterally tapered flexion springs in the second array and to a fourth end cap at the second end of the bilaterally tapered flexion springs in the second array.

16. The spring system according to claim 15, wherein the first end cap and the second end cap include a u-shaped channel.

17. The spring system according to claim 8, wherein the first pivotal joint and the second pivotal joint includes a bearing.

18. The spring system according to claim 17, wherein the bearing includes a journal bearing.

19. The spring system according to claim 17, wherein the bearing is a part of at least one the first spring interface and the second spring interface.

20. The spring system according to claim 19, wherein the first spring interface and second spring interface includes first plurality of ribs in the first spring interface positioned adjacent to the first pivotal joint and includes a second plurality of ribs in the second spring interface positioned adjacent to the second pivotal joint.

21. A spring system comprising:
an array of bilaterally tapered flexion springs, the bilaterally tapered flexion springs in the array shaped such that a width of the bilaterally tapered flexion springs decreases, at least in part, along a length of the bilaterally tapered flexion springs from a central region of the bilaterally tapered flexion springs to a first end of the bilaterally tapered flexion springs and the width of the bilaterally tapered flexion springs decreases, at least in part, along the length of the bilaterally tapered flexion springs from the central region of the bilaterally tapered flexion springs to a second end, the second end opposite the first end; and
a first end cap coupled to the first end of the bilaterally tapered flexion springs in the array of bilaterally tapered flexion springs and a second end cap coupled to the second end of the bilaterally tapered flexion springs in the array of bilaterally tapered flexion springs.

22. The spring system according to claim 21, wherein the first end cap and the second end cap include a u-shaped channel.

23. A method of manufacturing a spring system, the method comprising:
coupling a first bilaterally tapered flexion spring to a first spring interface in a first three point interfacing configuration, the first three point interfacing configuration including a first interface positioned on a first side of the first bilaterally tapered flexion spring and a second interface and a third interface positioned on a second side of the first bilaterally tapered flexion spring, the second side of the first bilaterally tapered flexion spring opposite the first side of the first bilaterally tapered flexion spring, the first interface positioned between the second interface and the third interface along a length of the first bilaterally tapered flexion spring; and
coupling a second bilaterally tapered flexion spring to a second spring interface in a second three point interfacing configuration, the second three point interfacing connection including a fourth interface positioned on a first side of the second bilaterally tapered flexion spring and a fifth interface and a sixth interface positioned on a second side of the second bilaterally tapered flexion spring, the second side of the second bilaterally tapered flexion spring opposite the first side of the second bilaterally tapered flexion spring, the fourth interface positioned between the fifth interface and the sixth interface along a length of the second bilaterally tapered flexion spring; and
bilaterally coupling the first spring interface to the second spring interface via a first pivotal joint and a second pivotal joint.
